(19) United States
(12) Patent Application Publication
(10) Pub. No.: US 2011/0232965 A1
(43) Pub. Date: Sep. 29, 2011

(54) Terminating Unit and Programmable Controller

(75) Inventors: Michael BRÄUNLICH, Chemnitz (DE); Hagen Böhme, Burkhardtsdorf (DE); Gunter Griessbach, Gelenau (DE); Daniela Rochlitzer, Chemnitz (DE); Dirk Schmidt, Zschorlau/OT Albernau (DE); Bernhard Weissbach, Frankenberg (DE)

(73) Assignee: Siemens Aktiengesellschaft, Munchen (DE)

(21) Appl. No.: 13/071,281

(22) Filed: Mar. 24, 2011

(30) Foreign Application Priority Data
Mar. 25, 2010 (EP) EP10157672

(51) Int. Cl. H02G 15/08

(52) U.S. Cl. 174/75 R

(57) ABSTRACT

A terminating unit comprising a first terminating device for a first data line, a second terminating device for a second data line, a third terminating device, and a connecting device which is arranged for electrically connecting the first and the second terminating device to the third terminating device A switch-over unit interacts with the connecting device such that in cases where the third terminating device is connected to a counterpiece, the first terminating device and the second terminating device are connected to the third terminating device and in cases where no counterpiece is terminated at the third terminating device, the first terminating device is connected to the second terminating device for connecting through the data lines.

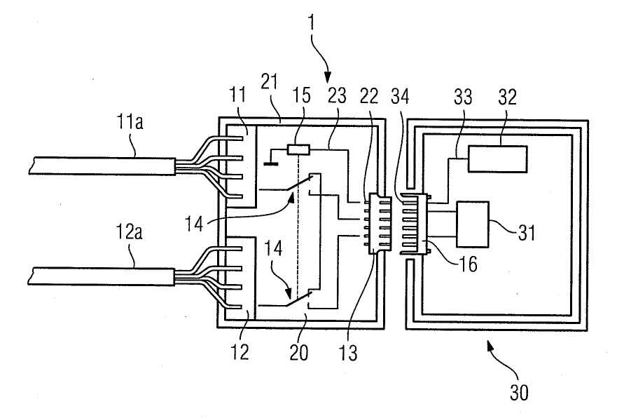

### BACKGROUND OF THE INVENTION

1. Field of the Invention

The invention relates to a terminating unit comprising a first terminating device for a first data line, a second terminating device for a second data line, a third terminating device, and a connecting device which is arranged for electrically connecting the first and second terminating devices to the third terminating device.

Furthermore, the invention relates to a programmable controller arranged for operation on a field bus, comprising a counterpiece for terminating a terminating unit.

2. Description of the Related Art

It is known that, in automation technology, for interconnecting programmable controllers, for example, field bus systems are configured not only as a star-shaped topology but also frequently as line topology. Particularly in the case of bus systems based on Ethernet technology, e.g., a PROFINET, the line topology has the disadvantage that switching off a bus user, such as a programmable controller, or pulling off a data cable of the bus, also disconnects the down-line bus users. Exchange processes or service actions at the bus users or programmable controllers connected thereto in running operation of the system are thus impaired or impossible.

### SUMMARY OF THE INVENTION

It is therefore an object of the present invention to provide a terminating unit which makes it possible to provide for a disconnection of the terminating unit from a programmable controller, such as programmable controllers configured in Ethernet technology and in-line topology, without the communication links to other automation components being interrupted.

This and other objects and advantages are achieved in accordance with the invention by providing a terminating unit having first, second, and third terminating devices, with a switch-over unit that interacts with a connecting device such that in the case where the third terminating device is terminated at a counterpiece, the first terminating device and the second terminating device are connected to the third terminating device. In cases where no counterpiece is terminated at the third terminating device, the first terminating device is connected to the second terminating device for connecting the data lines through. As a rule, a programmable controller that is designed for line topology, at which the terminating unit is terminated, where the programmable controller is configured in accordance with PROFINET technology, has data lines. Here, a first data line is an incoming data line and a second data line is an outgoing data line. Preferably, a two-port switch, at which the data lines forward their signals, is arranged within the programmable controller. Consequently, known terminating units are configured such that the first data line and the second data line are switched directly to the two-port switch arranged within the programmable controller. In cases where no programmable controller is terminated at the terminating unit, the line topology is interrupted at this point. In this interruption, the switch-over unit that interacts with the connecting device, such that this interruption does not occur, is advantageously used in the terminating unit.

In an embodiment of the terminating unit, a mechanical device is provided for mechanically operating the switch-over unit. For example, it is conceivable that in the case of a plug-in process of the terminating unit into the associated programmable controller, a sliding mechanism is triggered which, in turn, operates mechanical contacts in the switch-over unit that switch over the connecting device such that either the first and/or the second data lines can be separately conducted to the two-port switch within the programmable controller or correspondingly, if the terminating unit is not plugged, the first and the second data lines are connected through.

In an alternative embodiment, the third terminating device includes a signal contact that is connected to the switch-over unit to apply a signal to the switch-over unit when the counterpiece is terminated at the third terminating device. In the presently contemplated embodiment, a relay with closed-circuit contacts, for example, could be present in the terminating unit. If a voltage is present at the signal contact, voltage could be applied to an exciter coil of a relay and the corresponding relay contacts switch the first and second data lines separately through the third terminating device to the two-port switch arranged within the programmable controller. Conversely, if there is no signal voltage present at the signal contact, the signal lines of the first and second data lines are connected by the closed-circuit contacts such that the signal lines are looped through within the field bus. Instead of the relay circuit, it is also possible to use semiconductor circuits, e.g. FET (Field Effect Transistors), because the FETs are conducting without a voltage being present and become blocking FETs when a signal voltage is applied.

In this context, the terminating unit with its first and second terminating devices is preferably arranged for accommodating Ethernet data lines. These could be familiar RJ45 plug-in contacts or also insulation displacement connections.

The terminating unit and the programmable controller described subsequently are related to one another in accordance with the plug and socket principle.

In the case of a programmable controller arranged for operation on a field bus, with a counterpiece for terminating a terminating unit as previously described, the program mentioned initially is solved in that the counterpiece has a control contact that is wired such that a signal can be forwarded through the control contact to the signal contact and, as a result, the switch-over unit is controllable.

In this arrangement, the programmable controller preferably includes a control device that is connected to the control contact over a second control line, where the control device is arranged for providing the signal in dependence on an operating state of the programmable controller.

With the programmable controller of the presently contemplated embodiment in combination with the electrically operable terminating unit, the following possible applications are obtained: for diagnostic or commissioning purposes, the programmable controllers terminated at a field bus built up of Ethernet lines can be optionally disconnected and connected without influencing the communication for other field bus users on the field bus. Programmable controllers can be completely switched off, for example, for purposes of saving energy. After the renewed connection of the programmable controller and booting of the programmable controller, the programmable controller can be re-integrated in the field bus because the control device correspondingly drives the switch-over unit in the terminating unit within the programmable controller. Automated adding of spare or expansion components is also possible.

The advantage of the presently contemplated embodiment consists in that in the case of a failure, service or disconnection of programmable controllers to systems configured in line topology, only the system part directly affected can be separated from the communication whilst the capability of communicating with other system parts remains in existence or can be re-restored after a short disturbance, respectively.

In the case of automation systems that are configured in accordance with the contemplated embodiments, the programmable controllers with their communication modules must be arranged such that a short-term interruption and possibly bouncing processes at the contacts, which can lead to communication disturbances, are managed. Here, the configuration of the system with the programmable controllers and the field buses should be such that, in the case of a terminating unit being pulled off with the subsequent connecting-through of the data lines, a maximum permissible line length is not exceeded in the compound field bus. In addition, the communication circuits and the control device should be arranged so that the electrical characteristics of the transfer physics are maintained (impedance ratios, autonegotiation).

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to the attached FIGURE, in which:

A terminating unit and a programmable controller are shown in the FIGURE.

### DETAILED DESCRIPTION OF THE PREFERRED EMBODIMENTS

With reference to the FIGURE, a terminating unit 1 is arranged to be plugged into a programmable controller 30. Here, the terminating unit 1 comprises a first terminating device 11 for a first data line 11a, a second terminating device 12 for a second data line 12a, the electrical contact to the programmable controller 30 can be established with a third terminating device 13, where the third terminating device 13 is plugged into a fitting counterpiece 16 of the programmable controller 30. Within an enclosure 21, the terminating unit 1 has a circuit board 20 on which a switch-over unit 15 and a connecting device 14 are accommodated. The switch-over unit 15 can operate the connecting device 14 (indicated with an action line) such that electrical data signals of the first data line 11a and the second data line 12a are forwarded either directly through the third terminating device 13 to the counterpiece 16 of the programmable controller 30 or, should the programmable controller 30 not be terminated at the third terminating device 13, connect the first data line 11a and the second data line 12a correspondingly through so that a communication on a field bus is not influenced. For the normal case of communication, the first data line 11a is interconnected by the connecting device 14 such that the first data-line 11a is connected to a first input of a switch 31 and the second data line 12a is correspondingly connected to a second input of the switch 31. In this case, the switch 31 represents a two-port switch.

The switch-over unit 15 is connected to a signal contact 22 by a first control line 23. This signal contact 22 is arranged within the third terminating device 13. In the plugged-in state, the signal contact 22 engages a control contact 34 of the counterpiece 16. A control device 32 is terminated at the control contact 34 through a second control line 33. The control device 32 is arranged such that the control device 32 can provide a signal over the second control line 33, the control contact 34, the signal contact 22 and the first control line 23 to the switch-over unit 15 dependent on an operating state of the programmable controller 30. This signal that is provided ensures that the switch-over unit 15 in conjunction with the connecting device 14, the first data line 11a and the second data line 12a is correspondingly interconnected to the switch 31.

Switching over or interconnecting the data lines in the terminating unit 1 can be triggered, for example, by three switch-over causes. A fault case, such as a voltage failure of the programmable controller, a pull out of the terminating unit 1 or the terminating unit 1 not being plugged in, or a deliberate functional disconnection by the programmable controller 30 for, e.g., a diagnostic mode or an energy saving mode.

If in the case of a fault of the programmable controller 30 or in the case where the terminating unit 1 is not plugged in, no corresponding signal should arrive at the switch-over unit 15, then the switch-over unit 15 and the connecting device 14 interact such that the first data line 11a and the second data line 12a are connected through.

In the FIGURE, the connecting device 14 is shown symbolically, i.e., a connecting through of several wires of the data lines through several switches allocated to the wires is also possible.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A terminating unit, comprising:
a first terminating device for a first data line;
a second terminating device for a second data line;
a third terminating device;
a connecting device arranged for electrically connecting the first and the second terminating devices to the third terminating device; and
a switch-over unit configured to interact with the connecting device such that in cases in which the third terminating device is terminated at a counterpiece, the first terminating device and the second terminating device are connected to the third terminating and in cases where no counterpiece is terminated at the third terminating device, the first terminating device is connected to the second terminating device for connecting through the first and second data lines.

2. The terminating unit as claimed in claim 1, further comprising:
a mechanical device for mechanically operating the switch-over unit.

3. The terminating unit as claimed in claim 1, wherein the third terminating device includes a signal contact which is connected to the switch-over unit to apply a signal to the switch-over unit when the counterpiece is terminated at the third terminating device.

4. The terminating unit as claimed in claim 1, wherein the first and the second terminating devices are arranged for terminating Ethernet data lines.

5. A programmable controller arranged for operation on a field bus, comprising:
a counterpiece for terminating a terminating unit, the terminating unit comprising:
a first terminating device for a first data line;
a second terminating device for a second data line;
a third terminating device;
a connecting device arranged for electrically connecting the first and the second terminating devices to the third terminating device; and
a switch-over unit configured to interact with the connecting device such that in cases in which the third terminating device is terminated at the counterpiece, the first terminating device and the second terminating device are connected to the third terminating device and in cases where no counterpiece is terminated at the third terminating device, the first terminating device is connected to the second terminating device for connecting through the first and second data lines;
wherein the counterpiece includes a control contact which is wired such that a signal can be forwarded through the control contact to the signal contact and, as a result, the switch-over unit is controllable.

6. The programmable controller as claimed in claim 5, further comprising:
a control device connected to the control contact over a second control line, the control device being arranged for providing the signal dependent on an operating state.

7. The programmable controller as claimed in claim 6, wherein the operating state comprises a voltage failure and the control device is arranged such that the control device can still deliver a signal.
